(19) United States
(12) Patent Application Publication
(10) Pub. No.: US 2012/0010811 A1
(43) Pub. Date: Jan. 12, 2012

(54) ROUTE INFORMATION GENERATION DEVICE AND ROUTE INFORMATION GENERATION METHOD

(75) Inventor: Asako Hamada, Kanagawa (JP)

(73) Assignee: PANASONIC CORPORATION, Osaka (JP)

(21) Appl. No.: 13/256,743

(22) PCT Filed: Dec. 27, 2010
(86) PCT No.: PCT/JP2010/007574

§ 371 Date: Sep. 15, 2011

(30) Foreign Application Priority Data
Dec. 28, 2009 (JP) 2009-297401

(51) Int. Cl. G01C 21/00

(52) U.S. Cl. 701/468

(57) ABSTRACT

Provided is a moving path information generating apparatus that acquires the position necessary for generating moving path information at low power consumption. The moving path information generating apparatus includes an azimuth information acquisition section (11) that acquires azimuth information, an azimuth information change detection section (12) that detects a change in the azimuth information acquired by the azimuth information acquisition section, an azimuth information change information recording section (13) that records azimuth information change information including the azimuth information acquired by the azimuth information acquisition section when the azimuth information change detection section has detected the azimuth information change, position acquisition determination section (14) that commands position acquisition when the azimuth information change detection section detects azimuth information change and position acquisition has not been commanded at the time of a previous azimuth information change, position acquisition section (15) that receives a position acquisition command from the position acquisition determination section and performs position acquisition, position information recording section (16) that records position information including a position acquired by the position acquisition section, and moving path information generating section (17) that calculates a position that has not been acquired by the position acquisition section at the time of azimuth information change using the azimuth information change information and the position information and generates moving path information.

### TECHNICAL FIELD

The present invention relates to a moving path information generating apparatus and a method of generating moving path information that acquire positions using a global positioning system (GPS) and generate moving path information.

### BACKGROUND ART

In recent years, a GPS logger that acquires and records its position using a GPS is being increasingly popular. In addition, applications providing a function capable of creating a digital diary linked with photographs taken along the way, places and facilities of interest and the like are also very popular. As blogs are increasingly used, people are increasing who carry and routinely keep activating a GPS logger in everyday life as well as for a special day such as travel.

Conventionally, in regard to a moving path information generating apparatus such as a GPS logger, as a method of acquiring the position using a GPS, there is a known method which controls activation of a GPS using an azimuth information sensor with low power consumption per activation (for example, see patent literature 1).

FIG. 1 is a flowchart showing a position acquisition process of a conventional moving path information generating apparatus. First, the moving path information generating apparatus periodically acquires azimuth information using an azimuth information sensor (S160). When the amount of change in azimuth information exceeds a designated range, the moving path information generating apparatus detects it as a change in azimuth information (S161). When a change in azimuth information is detected, the moving path information generating apparatus acquires the position using the GPS, records the acquired position as position information (S162), and then finishes the position acquiring process (S163). However, when a change in azimuth information is not detected, the moving path information generating apparatus finishes the position acquiring process “as is” without acquiring the position using the GPS (S163). This flow is executed whenever an azimuth information sensor acquires azimuth information.

In the position acquiring process of FIG. 1, activation of the GPS can be suppressed by activating the GPS and acquiring the position when the amount of change in azimuth information exceeds the designated range.

### CITATION LIST

### Patent Literature

### PTL 1

Japanese Patent Application Laid-Open No. 2004-125544

### SUMMARY OF INVENTION

### Technical Problem

However, in the above method, since the position is acquired by activating the GPS each time when a change in azimuth information is detected, power consumption is still high.

In order to solve the above problem with the conventional method, the present invention is directed to provide a moving path information generating apparatus and a method of acquiring moving path information in which low power consumption is realized by suppressing acquisition of the position necessary for generating moving path information as much as possible.

### Solution to Problem

A moving path information generating apparatus according to the present invention includes an azimuth information acquisition section that acquires azimuth information by an azimuth information sensor, an azimuth information change detection section that detects a change in the azimuth information acquired by the azimuth information acquisition section, an azimuth information change information recording section that records azimuth information change information including the azimuth information acquired by the azimuth information acquisition section when the azimuth information change detection section has detected an azimuth information change, a position acquisition determination section that commands position acquisition when the azimuth information change detection section detects the azimuth information change and position acquisition has not been commanded at the time of a previous azimuth information change, a position acquisition section that receives a position acquisition command from the position acquisition determination section and performs position acquisition, a position information recording section that records position information including a position acquired by the position acquisition section, and a moving path information generating section that calculates a position that has not been acquired by the position acquisition section at the time of azimuth information change using the azimuth information change information and the position information and generates moving path information.

Through implementation of these steps, the number of times of position acquisition necessary for generating moving path information can be reduced, and thus the operation time of apparatus can increase.

A method of generating moving path information according to the present invention includes an azimuth information acquisition step of acquiring an azimuth, an azimuth information change detection step of detects a change in the azimuth information acquired in the azimuth information acquisition step, an azimuth information change information recording step of recording azimuth information change information including the azimuth information acquired in the azimuth information acquisition step when the azimuth information change is detected in the azimuth information change detection step, a position acquisition determination step of commanding position acquisition when the azimuth information change has been detected in the azimuth information change detection step and position acquisition has not been commanded at the time of a previous azimuth information change, a position acquisition step of receiving position acquisition when a position acquisition command is output in the position acquisition determination step, a position information recording step of recording position information including a position acquired in the position acquisition step, and a moving path information generation step of calculating a position that has not been acquired in the position acquisition step at the time of azimuth information change using the azimuth information change information and the position information and generating moving path information.

Through implementation of these steps, the number of times of position acquisition necessary for generating moving path information can be reduced, and thus the operation time of apparatus can increase.

A moving path information generating system according to the present invention includes a position acquisition control terminal, and a moving path information generating apparatus, wherein the position acquisition control terminal includes an azimuth information acquisition section that acquires azimuth information, an azimuth information change detection section that detects a change in the azimuth information acquired by the azimuth information acquisition section, an azimuth information change information recording section that records azimuth information change information from the azimuth information change detection section when the azimuth information change detection section has detected the azimuth information change, a position acquisition determination section that commands position acquisition when the azimuth information change detection section detects the azimuth information change and position acquisition has not been commanded at the time of a previous azimuth information change, a position acquisition section that receives a position acquisition command from the position acquisition determination section and performs position acquisition, a position information recording section that records position information including a position acquired by the position acquisition section, and a transmission section that transmits the azimuth information change information and the position information, and the moving path information generating apparatus includes a reception section that receives the azimuth information change information and the position information and a moving path information generating section that calculates a position that has not been acquired at the time of azimuth information change using the azimuth information change information and the position information and generates moving path information.

Through implementation of this configuration, the number of times of position acquisition necessary for generating moving path information can be reduced, and thus the operation time of apparatus can increase.

A position acquisition control terminal according to the present invention includes an azimuth information acquisition section that acquires azimuth information, an azimuth information change detection section that detects a change in the azimuth information acquired by the azimuth information acquisition section, an azimuth information change information recording section that records azimuth information change information from the azimuth information change detection section when the azimuth information change detection section has detected the azimuth information change, a position acquisition determination section that commands position acquisition when the azimuth information change detection section detects the azimuth information change and position acquisition has not been commanded at the time of a previous azimuth information change, a position acquisition section that receives a position acquisition command from the position acquisition determination section and performs position acquisition, a position information recording section that records position information including a position acquired by the position acquisition section, and a transmission section that transmits the azimuth information change information and the position information.

Through implementation of this configuration, the number of times of position acquisition necessary for generating moving path information can be reduced, and thus the operation time of apparatus can increase.

### Advantageous Effects of Invention

According to the present invention, the number of times of position acquisition necessary for generating moving path information can be reduced, and thus the operation time of apparatus can increase.

### BRIEF DESCRIPTION OF DRAWINGS

FIG. 1 is a flowchart of a conventional position acquisition process;

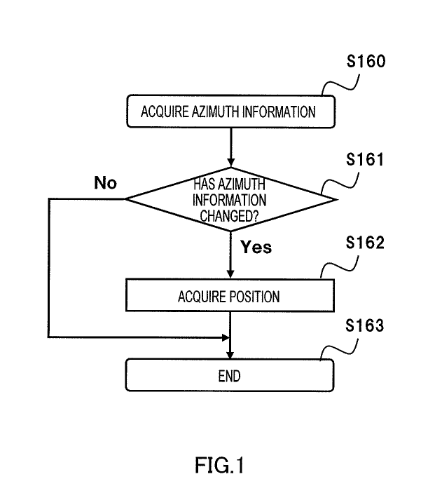

FIG. 2 is a configuration diagram of a moving path information generating apparatus according to Embodiment 1 of the present invention;

FIG. 3 is a flowchart of a position acquisition process according to Embodiment 1 of the present invention;

FIG. 4 is a flowchart of a moving path information generation process according to Embodiment 1 of the present invention;

FIG. 5 is a view showing a specific example of position information;

FIG. 6 is a view showing a specific example of azimuth information change information;

FIG. 7 is a view showing a movement path of a moving path information generating apparatus;

FIG. 8 is a view showing that position information and azimuth information change information are indicated on a map;

FIG. 9 is a view showing that a result of a moving path information generation process is indicated on a map;

FIG. 10 is a view showing a specific example of moving path information;

FIG. 11 is a view showing a specific example of digital map data;

FIG. 12 is a view showing digital map data of FIG. 10;

FIG. 13 is a view showing an example of moving path information mapped with a digital map;

FIG. 14 is a flowchart of a position acquisition process according to Embodiment 2 of the present invention;

FIG. 15 is a flowchart of a moving path information generation process according to Embodiment 2 of the present invention;

FIG. 16 is a configuration view of a moving path information generating system according to Embodiment 3 of the present invention;

FIG. 17 is a configuration view of a moving path information generating apparatus according to Embodiment 4 of the present invention;

FIG. 18 is a configuration view of a moving path information generating apparatus according to Embodiment 5 of the present invention;

FIG. 19 is a flowchart of a position correction process according to Embodiment 5 of the present invention;

FIG. 20 is a view showing a specific example of position information;

FIG. 21 is a view showing a specific example of azimuth information change information; and

FIG. 22 is a configuration view of a moving path information generating system according to Embodiment 6 of the present invention.

### DESCRIPTION OF EMBODIMENTS

Now, embodiments of the present invention will be described in detail with reference to the accompanying drawings.

### Embodiment 1

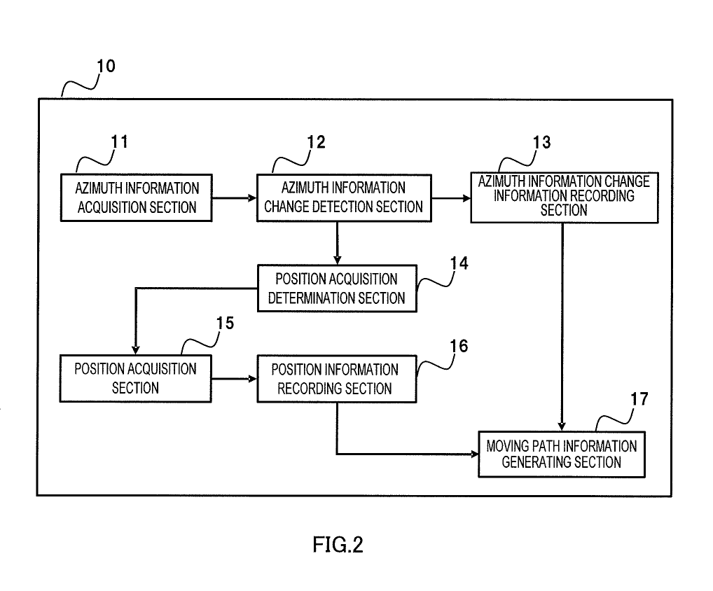

FIG. 2 is a configuration diagram of moving path information generating apparatus 10 according to Embodiment 1 of the present invention.

Referring to FIG. 2, moving path information generating apparatus 10 includes azimuth information acquisition section 11, azimuth information change detection section 12, azimuth information change information recording section 13, position acquisition determination section 14, position acquisition section 15, position information recording section 16, and moving path information generating section 17. For example, moving path information generating apparatus 10 can be used as a small terminal carried by people such as a portable telephone or a personal digital assistant (PDA).

First, a description will be made in connection with functions of components of moving path information generating apparatus 10.

Azimuth information acquisition section 11 is periodically activated, acquires azimuth information, and transmits the acquired azimuth information to azimuth information change detection section 12. Azimuth information acquisition section 11 may be implemented by a magnetic sensor or an electronic compass. An azimuth information acquisition cycle of azimuth information acquisition section 11 may be automatically received from the outside on the street and updated through a wireless communication. Thus, moving path information generating apparatus 10 can determine the azimuth information acquisition cycle according to characteristics of its location. The azimuth information acquisition cycle is set to be short at a place having many alleys or a region where roads are densely located but is set to be long in a region where a space between roads is large. The azimuth information acquisition cycle may be set by a user in advance.

Azimuth information change detection section 12 is retaining azimuth information (hereinafter, referred to as “previous azimuth information”) when a previous azimuth information change has been detected thereinside. When new azimuth information is received from azimuth information acquisition section 11, azimuth information change detection section 12 compares the new azimuth information with the previous azimuth information and determines that there has been an azimuth information change when a difference between the new azimuth information and the previous azimuth information is equal to or more than a threshold value. Then, azimuth information change detection section 12 notifies position acquisition determination section 14 and azimuth information change information recording section 13 of the previous azimuth, the present azimuth, and a time when the azimuth information change has occurred together with the fact that the azimuth information change has occurred. Further, azimuth information change detection section 12 replaces the previous azimuth information retained thereinside with the azimuth information (hereinafter, referred to as “present azimuth”) currently acquired by azimuth information acquisition section 11.

Azimuth information change information recording section 13 records the time at which the azimuth information change has occurred, the previous azimuth, and the present azimuth, as azimuth information change information. The previous azimuth information has been already recorded as azimuth information change information even when the previous azimuth information change has been detected. Thus, in order to reduce the amount of data, azimuth information change information recording section 13 may not record the previous azimuth. Further, the time when the azimuth information change has occurred is used for the purpose of recognizing an order of an azimuth information change, and thus a number or the like may be assigned instead of a time.

Position acquisition determination section 14 is retaining a position acquisition flag thereinside. The position acquisition flag refers to a flag representing whether a position acquisition command has been given to position acquisition section 15 when there has been the previous azimuth information change. Position acquisition determination section 14 determines whether the position is to be acquired by referring to the position acquisition flag and commands position acquisition section 15 to perform position acquisition when it is determined that the position is to be acquired. Further, when there has been the previous azimuth information change, whether the position acquisition command has been given to position acquisition section 15 may be determined based on a comparison result of the azimuth information change information and the position information. Thus, position acquisition section 15 may not set up the position acquisition flag.

Position acquisition section 15 receives the position acquisition command from position acquisition determination section 14 and acquires the position. Position acquisition section 15 may be implemented by a GPS module that can perform GPS reception and position calculation.

Position information recording section 16 records the time at which the azimuth information that is received from azimuth information change detection section 12 changes and the position (the latitude and the longitude) that position acquisition section 15 has acquired as the position information. Position information recording section 16 may record only the time when the azimuth information change has occurred (the position is blank) when the position has not been acquired in spite of the fact that the azimuth information change has occurred.

Moving path information generating section 17 generates moving path information based on the position information recorded in position information recording section 16 and the azimuth information change information recorded in azimuth information change information recording section 13.

Next, a position acquisition process of moving path information generating apparatus 10 will be described.

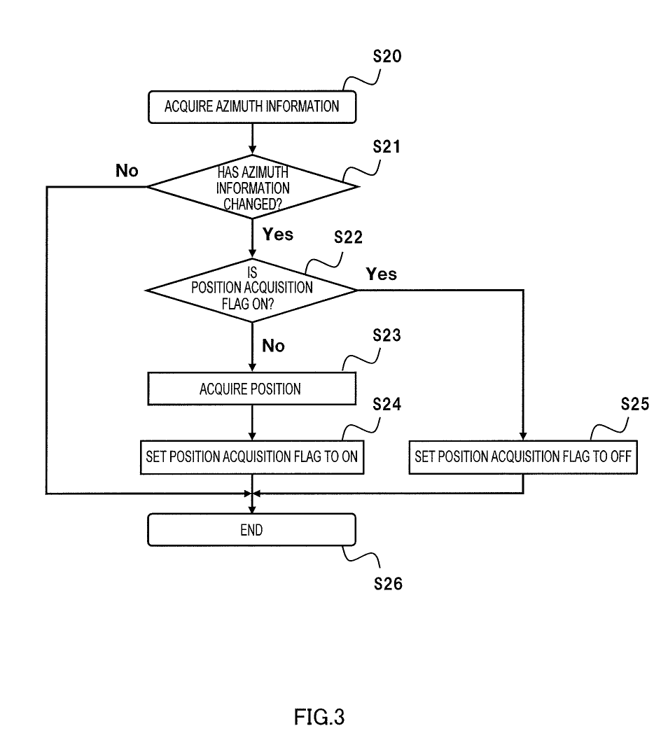

FIG. 3 is a flowchart of the position acquisition process of moving path information generating apparatus 10.

First, when azimuth information acquisition section 11 acquires azimuth information (S20), azimuth information change detection section 12 determines whether there has been an azimuth information change (S21). A determination on the azimuth information change is performed by comparing a new azimuth information with a previous azimuth information when the new azimuth information is acquired. When a difference between the new azimuth information and the previous azimuth information is equal to or more than a threshold value, it is determined that there has been the azimuth information change. When there has not been the azimuth information change, moving path information generating apparatus 10 finishes the position acquisition process (S26). When it is determined that there has been the azimuth information change, position acquisition determination section 14 determines whether the position acquisition flag is “ON” by referring to the position acquisition flag (S22).

Position acquisition determination section 14 commands position acquisition section 15 to perform position acquisition when the position acquisition flag is OFF, that is, when there has been the previous azimuth information change but the position has not been acquired. Position acquisition section 15 receives the position acquisition command from position acquisition determination section 14 and acquires the position (S23). Then, position acquisition determination section 14 sets the position acquisition flag to ON (S24) and finishes the position acquisition process (S26).

Meanwhile, when the position acquisition flag is ON, that is, when there has been the previous azimuth information change and then the position has been acquired, position acquisition determination section 14 sets the position acquisition flag to OFF (S25) and finishes the position acquisition process (S26) without commanding position acquisition section 15 to perform position acquisition.

Further, when the position acquisition flag is not set up, position acquisition determination section 14 determines whether the position acquisition command is to be given to position acquisition section 15 based on the comparison result of the azimuth information change information and the position information. Specifically, position acquisition determination section 14 confirms whether a record of position information having a time (or number) matching with a time (or number) of a record when there has been the previous azimuth information change of the azimuth information change information has been recorded in position information recording section 16. When recorded, position acquisition determination section 14 determines that the position acquisition has been performed at the time of the previous azimuth information change and so does not command position acquisition section 15 to perform position acquisition. However, when not recorded, position acquisition determination section 14 determines that the position acquisition has not been performed at the time of the previous azimuth information change and so commands position acquisition section 15 to perform position acquisition.

Next, a specific example of a moving path information generation process of moving path information generating apparatus 10 will be described.

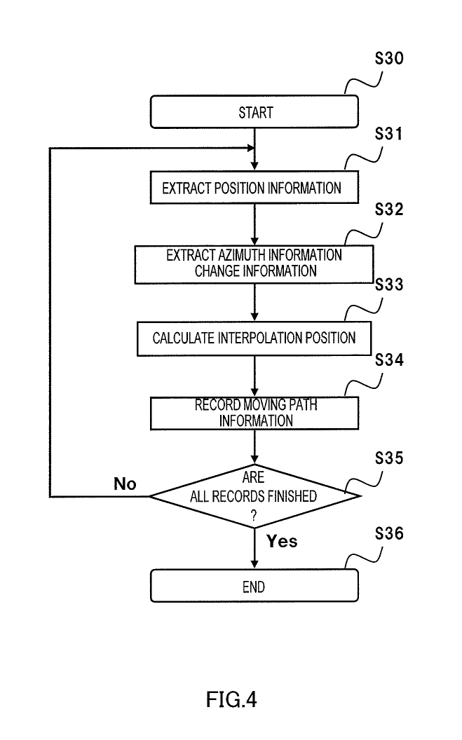

FIG. 4 is a flowchart of the moving path information generation process performed by moving path information generating section 17.

When the moving path information generation process starts (S30), moving path information generating section 17 extracts two position information records in a range for generating moving path information from the position information recorded in position information recording section 16 in the order of earlier time (S31). A method of determining the range for generating the moving path information will be described below.

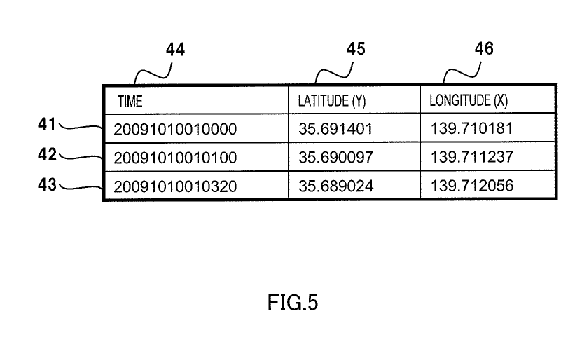

FIG. 5 shows a specific example of the position information recorded in position information recording section 16. Referring to FIG. 5, the position information is configured such that a set including time 44 when an azimuth information change has occurred and a position (latitude (Y) 45 and longitude (X) 46) acquired by position acquisition section 15 is recorded as one record. In an example of FIG. 5, record 41, record 42, and record 43 are recorded. If all of them are included in the range for generating the moving path information, record 41 and record 42 are first extracted. For convenience of description, of the extracted two position information records, a record that is earlier in time is referred to as a “previous position,” and a record that is late in time is referred to as a “next position.” Between the two position information records, there may be included a position information record in which position acquisition is omitted in spite of the fact that there has been an azimuth information change.

Next, moving path information generating section 17 extracts two azimuth information change information records corresponding to the two position information records (record 41 and record 42) extracted in step S31 from azimuth information change information recording section 13 (S32). Specifically, moving path information generating section 17 compares a time of the position information record with a time of the azimuth information change information record and extracts the azimuth information change information record when matching records are found.

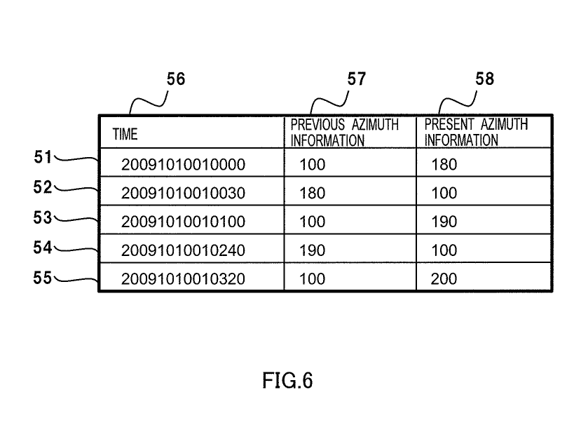

FIG. 6 shows the azimuth information change information recorded in azimuth information change information recording section 13. Referring to FIG. 6, the azimuth information change information is configured such that a set including time 56 when an azimuth information change has occurred, previous azimuth information 57, and present azimuth information 58 is recorded as one record. The azimuth information is represented such that the north is 0°, the east is 90°, the south is 180°, and the west is 270°. In the examples of FIGS. 5 and 6, a time of position information record 41 matches with a time of azimuth information change information record 51. Further, a time of position information record 42 matches with a time of azimuth information change information record 53. Thus, moving path information generating section 17 extracts record 51 and record 53 of the azimuth information change information that match in time with record 41 and record 42 of the position information from azimuth information change information recording section 13.

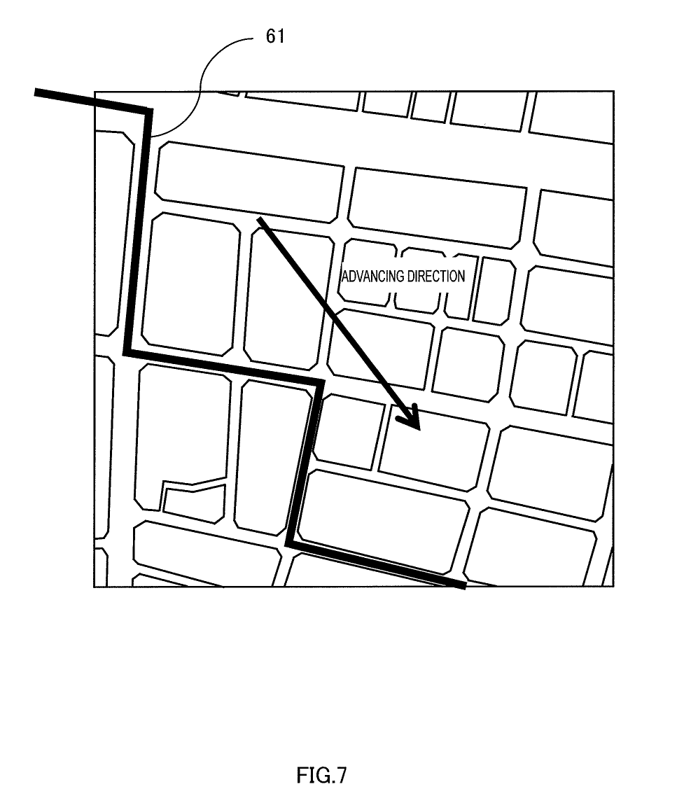

FIG. 7 is a view showing an example of a movement path through which moving path information generating apparatus 10 has actually moved, in Embodiment 1. Moving path information generating apparatus 10 is moving from upper left toward lower right through route 61.

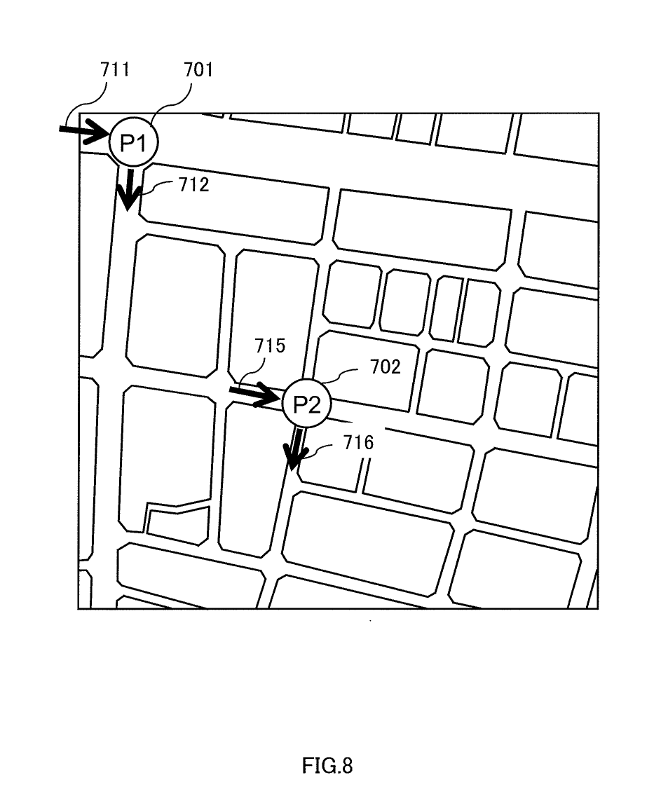

FIG. 8 is a view showing that the position information extracted in step S31 and the azimuth information change information extracted in step S32 are indicated on a map of FIG. 7.

Point P1 701 represents the position (the latitude and the longitude) of position information record 41. Reference numerals 711 and 712 represent the previous azimuth information and the present azimuth information of azimuth information change information record 51. Similarly, point P2 702 represents the position (the latitude and the longitude) of position information record 42. Reference numerals 715 and 716 represent the previous azimuth information and the present azimuth information of azimuth information change information record 53.

In step S32, moving path information generating section 17 extracts the two position information records. Further, moving path information generating section 17 extracts a time when there has occurred an azimuth information change of an azimuth information change information record (in this case, record 52) present between the two records (record 51 and record 53).

Next, moving path information generating section 17 calculates the interpolation position based on the two position information records extracted in step S31 and the two azimuth information change information records extracted in step S32 (S33). The interpolation position refers to the position that is present between the two position information records extracted in step S31 and position acquisition has been omitted in spite of the fact that there has been an azimuth information change. The interpolation position may be obtained by calculating an intersection point of two straight lines.

One straight line is derived for the previous position (an earlier one of the extracted two position information records) using the position (the latitude and the longitude) of position information record 41 and the present azimuth information of azimuth information change information record 51. The other straight line is derived for the next position (a late one of the extracted two position information records) using the position (the latitude and the longitude) of position information record 42 and the previous azimuth information of azimuth information change information record 53.

Since the azimuth information of the azimuth information change information becomes the amount of change from the north, when transformed into a coordinate axis having the east as an X axis and the north as a Y axis is performed, the slope to the X axis becomes “90°-azimuth.”

Thus, the straight line in the XY axis can be represented by equation 1:

Y=tan(2π×(90°−azimuth)/360°)(X−longitude)+latitude (Equation 1)

Here, when the azimuth information is 0°, X is the longitude.

Thus, since the azimuth information is 0°, the straight line having the previous position as a base point is obtained based on the position (the latitude and the longitude) of position information record 41 and present azimuth information of azimuth information change information record 51 as follows:

X=139.710181 (Equation 2)

That is, straight line X is the longitude of record 41.

The straight line having the next position as a base point can be obtained by calculating equation 1 of the straight line based on the position (the latitude and the longitude) of position information record 42 and the previous azimuth information of azimuth information change information record 53:

Y=tan(2π×(90°-100°)/360°)(X−139.711237)+35.690097 (Equation 3)

Moving path information generating section 17 obtains the intersection point using the two simultaneous linear equations, that is, equations 2 and 3. As the intersection point, X is 139.710181, and Y is 35.690283. This intersection point is the interpolation position between the two points.

Further, in an exceptional case in which it is difficult to calculate the interpolation position, moving path information generating section 17 may regard the previous position or the next position as the interpolation position or may estimate the interpolation position from a movement speed and a movement time. The movement speed may be extracted using another inertial sensor such as an acceleration sensor or a walking sensor or may be set in advance. The movement time may be calculated based on a difference between a time of the previous position (or the next position) and a time of the interpolation position. As a case in which it is difficult to calculate the interpolation position, there may be considered a case in which the two straight lines become almost parallel to each other such as when a U turn is made.

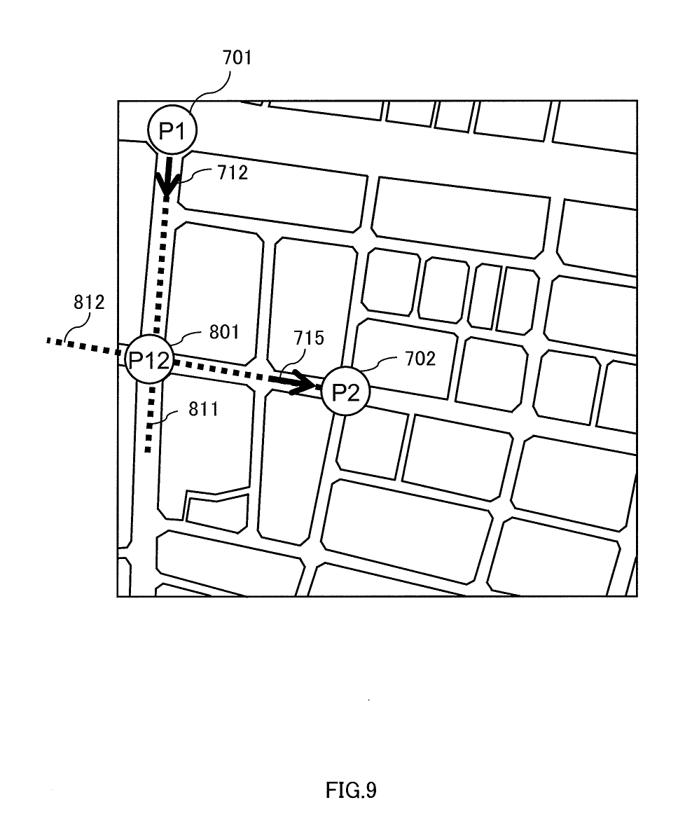

FIG. 9 is a view showing that a result of a moving path information generation process is indicated on a map.

Reference numeral 811 represents straight line X of equation 2, and reference numeral 812 represents straight line Y of equation 3. Point P12 801 represents the interpolation position.

Moving path information generating section 17 records the time and the position (the latitude and the longitude) of previous position 701, the time and the position (the latitude and the longitude) of interpolation position 801, and the time and the position (the latitude and the longitude) of next position 702 in a time sequential order as three moving path information records (S34).

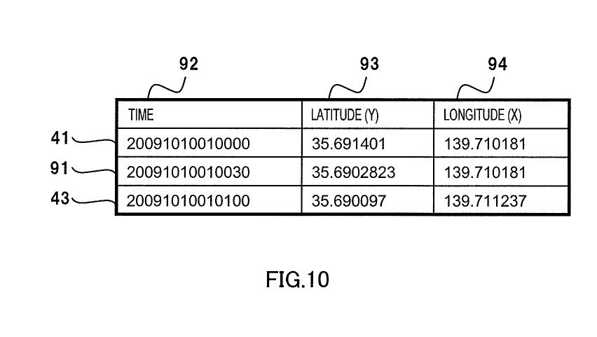

FIG. 10 shows a specific example of the moving path information obtained by performing the moving path information generation process. The moving path information is configured such that a set of time 92, latitude 93, and longitude 94 is recorded in moving path information generating section 17 as one record 91. The time extracted in step S32 is set as a time of the interpolation position.

Moving path information generating section 17 determines whether processing of all records is finished (S35). When it is determined as not finished, the processes of steps S31 to S34 are repetitively performed on all position information records for generating the moving path information. Following record 41 and record 42 of position information, record 42 and record 43 of position information are extracted. Here, record 42 is the previous position, and record 43 is the next position.

When processing of all records is finished, moving path information generating section 17 finishes the moving path information generation process (S36).

As described above, moving path information generating apparatus 10 according to the present embodiment can derive the two straight lines using the position information and the azimuth information change information of the two positions (the previous position and the next position). By solving the simultaneous linear equations, the intersection point (the interpolation position) of the two straight lines can be obtained.

Position acquisition determination section 14 determines whether the position is to be acquired by referring to the position acquisition flag under the assumption that the interpolation position can be obtained by the subsequent moving path information generation process.

Further, moving path information generating apparatus 10 performs the moving path information generation process in response to a user's command or periodically. As the range on which the moving path information generation process is to be performed, selected is a range on which the previous moving path information generation process has not been performed among the position information recorded in moving path information recording section 16. A range of the next moving path information generation process is determined based on a time of the last record of the moving path information stored thereinside. In the case of the moving path information of FIG. 10, the moving path information generation process starts starting from a position information record (record 42 in the case of FIG. 5) having a time matching with a time of last record 42.

Alternatively, in step S33, moving path information generating section 17 may calculate the interpolation position using map matching.

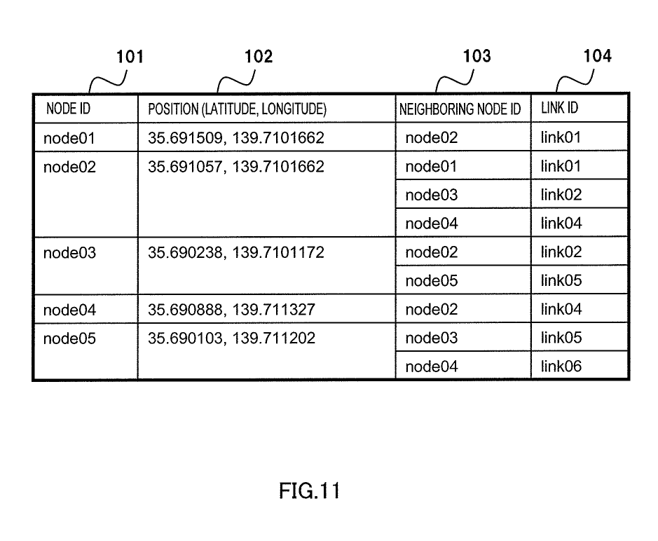

FIG. 11 shows an example of digital map data used for map matching.

Referring to FIG. 11, the digital map data includes node ID 101 that is set in units of intersection points, branch points, or the like, node position information (the latitude and the longitude) 102, neighboring node ID 103, link ID 104 that is set in units of roads that connect a node with a neighboring node, and the like.

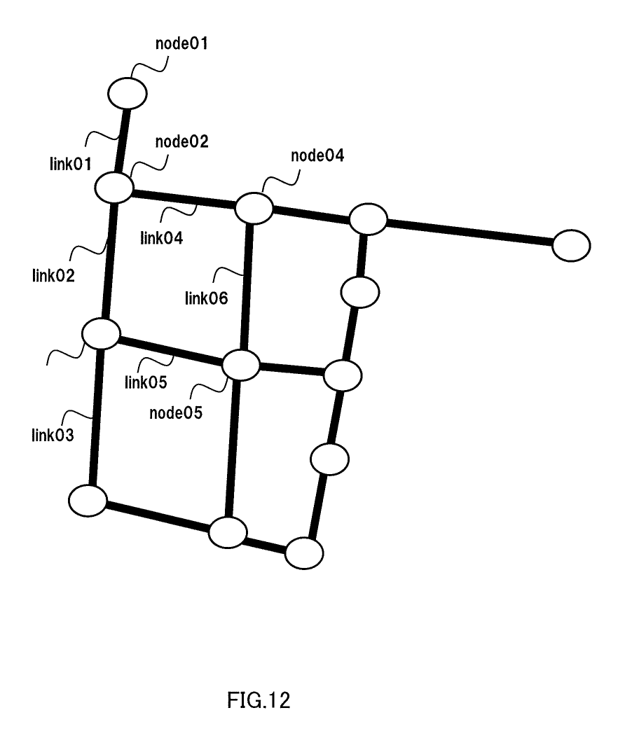

FIG. 12 is diagrammatic representation of FIG. 11.

Moving path information generating section 17 retrieves nodes that are smallest in distance with the positions of the two position information records (record 41 and record 42) extracted in step S31 from the digital map data. As a result of retrieval, node 01 and node 05 are extracted as nodes that are closest to record 41 and record 42, respectively.

Next, of the two azimuth information change information records (record 51 and record 53) extracted in step S32, moving path information generating section 17 calculates two unit vectors from the present azimuth information of record 51 and the previous azimuth information of record 53. Further, moving path information generating section 17 calculates a unit vector of vector connecting node 01 with a neighboring node thereof (node 02) and a unit vector of vector connecting node 05 with neighboring node thereof (node 03 and node 04).

Then, moving path information generating section 17 retrieves a unit vector of vector connecting node 01 with a neighboring node which is highest in consistency (smallest in scalar value obtained as a subtraction result of vectors) with a unit vector calculated from the present azimuth information of record 51. In this case, since a unit vector of vector connecting node 01 with node 02 is highest in consistency, node 02 is extracted as a node configuring a path. Similarly even on a unit vector calculated from the previous azimuth information of record 53, moving path information generating section 17 retrieves a unit vector of vector connecting node 05 with a neighboring node that is highest in consistency. In this case, node 03 is extracted as a node configuring a path.

Thereafter, moving path information generating section 17 performs the path retrieval so as to connect nodes with each other and specifies a halfway node present between the nodes in order of node 01, node 02, node 03, and node 05 and a link ID that is road information. As a result of retrieval, it can be understood that a route is an order of node 01, node 02, node 03, and node 05.

The link ID is linked with the property related to a road such as the road width or road regulations necessary when suggesting to the user or a road object on a map display. Here, a description thereof will not be repeated.

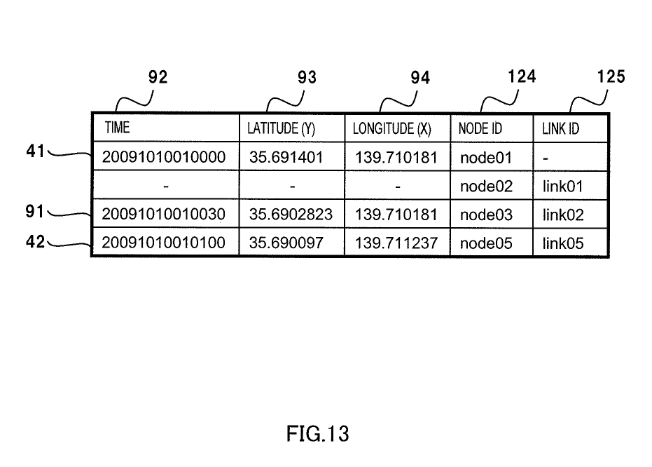

FIG. 13 shows an example in which mapping with a digital map is performed using map matching as an example using road information. Referring to FIG. 13, the moving path information includes time 92, latitude 93, longitude 94, node ID 124, and link ID 125. In the map display, by specifying the road object from link ID 125, it is possible to draw a movement path.

As described above, moving path information generating apparatus of the present embodiment can reduce the number of times of position acquisition necessary for generating the moving path information and increase the operation time of apparatus by calculating the interpolation position based on the position information and the azimuth information change information.

### Embodiment 2

Embodiment 2 is different from Embodiment 1 in the position acquisition process and the moving path information generation process.

First, a position acquisition process according to Embodiment 2 will be described.

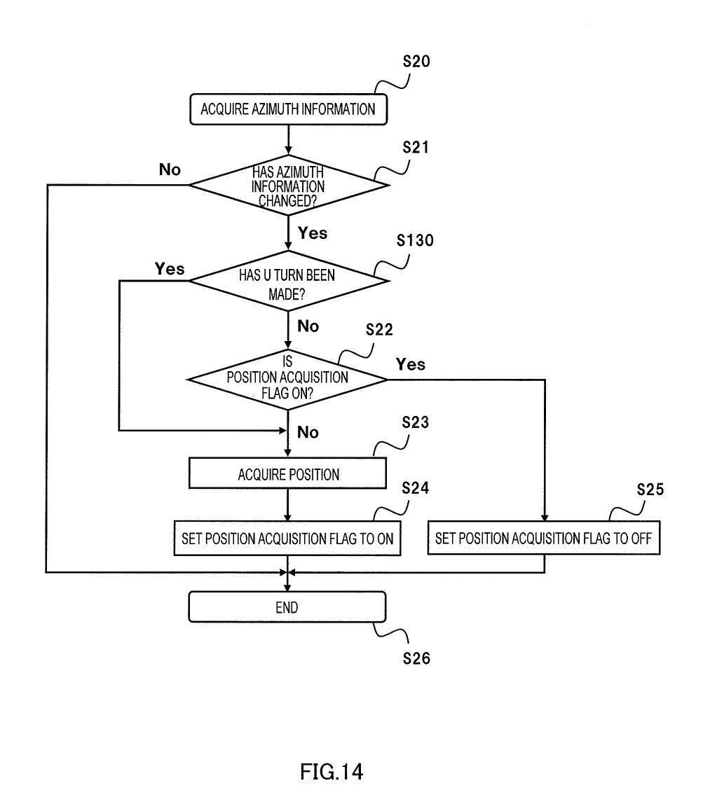

FIG. 14 is a flowchart of the position acquisition process according to Embodiment 2.

The same steps as in Embodiment 1 are assigned the same reference numerals. A step different from Embodiment 1 is step S130. In the present embodiment, for example, when moving path information generating apparatus 10 makes a U turn, an exceptional process is performed.

In step S130, position acquisition determination section 14 determines whether moving path information generating apparatus 10 has made a U turn. A determination as to whether a U turn has been made is performed such that a difference (the amount of azimuth information change) between the previous azimuth information and the present azimuth information received from azimuth information change detection section 12 is obtained, and it is determined that a U turn has been made when the amount of azimuth information change is 180±α° (a is within an error range and is a settable parameter). When a U turn has been made, regardless of whether the position acquisition flag is ON/OFF, position acquisition determination section 14 commands position acquisition section 15 to perform position acquisition (S23) and then sets the position acquisition flag to ON (S24). When a U turn has not been made, position acquisition determination section 14 proceeds to step S22 and performs the same process as in Embodiment 1.

Next, the moving path information generation process according to Embodiment 2 will be described.

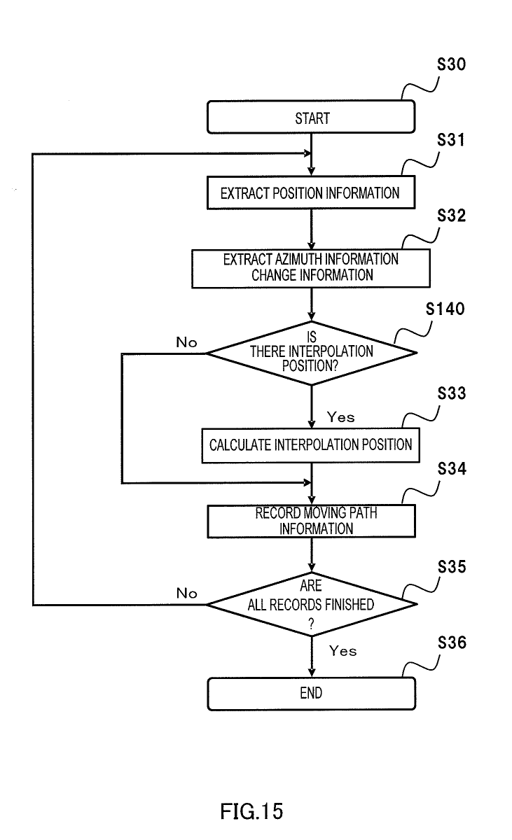

FIG. 15 is a flowchart of the moving path information generation process according to Embodiment 2.

The same steps as in Embodiment 1 are assigned the same reference numerals. A step different from Embodiment 1 is step S140.

In step S140, moving path information generating section 17 determines whether an azimuth information change information record (a record corresponding to the interpolation position) is present between the times of the two position information records extracted in step S31. When the record corresponding to the interpolation position is not present, moving path information generating section 17 determines that a U turn has been made, and records the two position information records as moving path information records “as is” without calculating the interpolation position (S34). When the record corresponding to the interpolation position is present, moving path information generating section 17 proceeds to step S33 and performs the same process as in Embodiment 1.

Further, when it is determined that a U turn has been made, position acquisition determination section 14 may add a flag representing a U turn and record the flag in position information recording section 16. Thus, moving path information generating section 17 can determine whether a U turn has been made through the U turn flag.

As described above, moving path information generating apparatus according to the present embodiment can generate the accurate moving path information more than Embodiment 1 by acquiring the position without omitting the position acquisition at the time of a U turn in which it is difficult to obtain the intersection point of the two straight lines (the interpolation position).

### Embodiment 3

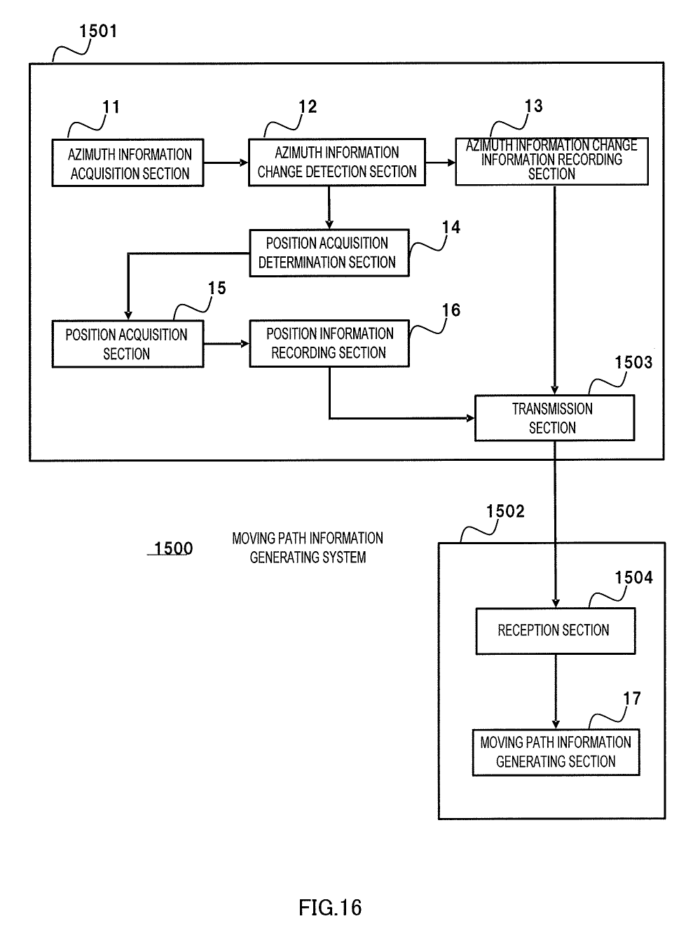

FIG. 16 is a configuration view of moving path information generating system 1500 according to the present embodiment. In FIG. 16, the same components as in FIG. 2 are assigned the same reference numerals.

Moving path information generating system 1500 according to Embodiment 3 of the present invention includes position acquisition control terminal 1501 and moving path information generating apparatus 1502.

Position acquisition control terminal 1501 according to the present embodiment has a configuration in which position information acquisition is separate from a moving path information generation process and is different from moving path information generating apparatus 10 of FIG. 2 in that moving path information generating section 17 is not disposed, and transmission section 1503 is disposed. For example, position acquisition control terminal 1501 can be used for a small terminal carried by people, such as a portable telephone or a PDA.

Moving path information generating apparatus 1502 includes moving path information generating section 17 that is the same as that of moving path information generating apparatus 10 of FIG. 2 and reception section 1504. Moving path information generating apparatus 1502 can be used for a server on the Internet, a personal computer (PC) at home, or the like.

Transmission section 1503 has a function of transmitting data to moving path information generating apparatus 1502. Transmission section 1503 transmits the position information recorded in position information recording section 16 and the azimuth information change information recorded in azimuth information change information recording section 13 to moving path information generating apparatus 1502 via an Internet connection or the like.

Reception section 1504 has a function of receiving data from position acquisition control terminal 1501. Reception section 1504 receives the position information and the azimuth information change information from position acquisition control terminal 1501 and transfers them to moving path information generating section 17.

The position acquisition process by position acquisition control terminal 1501 is the same as in Embodiment 1. As the position acquisition process by position acquisition control terminal 1501, the same process as in Embodiment 2 may be performed.

The moving path information generation process of moving path information generating apparatus 1502 is the same as in Embodiment 1. As the moving path information generation process of moving path information generating apparatus 1502, the same process as in Embodiment 2 may be performed.

As described above, moving path information generating system 1500 according to the present embodiment can reduce the number of times of position acquisition for necessary for generating the moving path information and increase the operation time of the terminal by calculating the interpolation position based on the position information and the azimuth information change information.

Further, position acquisition control terminal 1501 can reduce the number of times of position acquisition by position acquisition determination section 14 and increase the operation time of the terminal.

Furthermore, moving path information generating apparatus 1502 according to the present embodiment can use moving path information of a plurality of position acquisition control terminals and thus can be used for other operations, for example, an operation for performing a traffic survey or an operation for estimating a damaged state of a road at the time of disaster.

Further, the following applications can be made through Embodiments 1 to 3.

Moving path information generating apparatus 10 may have a control mode and a normal mode as a position acquisition mode. The control mode refers to a mode for performing the position acquisition process (FIGS. 3 and 14) according to Embodiment 1 or Embodiment 2. The normal mode refers to a mode in which azimuth information acquisition section 11 stops azimuth information acquisition and position acquisition section 15 acquires the position at previously set intervals regardless of a change in azimuth information.

For example, switching between the modes may be implemented by installing mode switching section in moving path information generating apparatus 10. Mode switching section commands azimuth information acquisition section 11 to turn on/off azimuth information acquisition. Further, mode switching section commands a control mode for acquiring the position according to the command of position acquisition determination section 14 or a normal mode for periodically acquiring the position by timer setting of position acquisition section 15 inside.

Mode switching section may monitor a position recording state of position information recording section 16 and switch the control mode to the normal mode when the number of times of position acquisition is equal to or more than a threshold value during a previously set time period.

When the azimuth information change information record corresponding to the position information by the process of step S23 of FIGS. 3 and 14 is not present, moving path information generating section 17 may determine it as an operation in the normal mode. In this case, moving path information generating section 17 may use the position information as the moving path information “as is” without the azimuth information change information.

Further, when an operation is performed in the normal mode, position acquisition section 15 may notify position information recording section 16 of the fact, and position information recording section 16 may record a flag representing the normal mode for each position information record. In this case, moving path information generating section 17 may perform the moving path information generation process in the normal mode without retrieving the azimuth information change information record corresponding to the position information.

### Embodiment 4

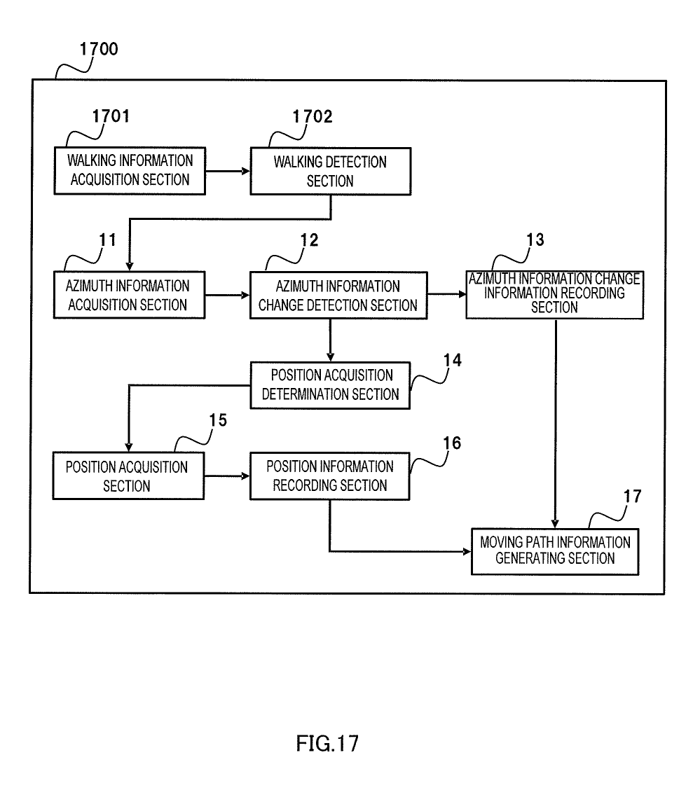

FIG. 7 is a configuration diagram of moving path information generating apparatus 1700 according to Embodiment 4 of the present invention. A configuration of Embodiment 4 is a configuration in which a function of controlling activation of position acquisition is added to the configuration of Embodiment 1, and thus an operation of azimuth information acquisition section 11 is different from Embodiment 1. The same parts as the configuration of Embodiment 1 are assigned the same reference numerals, and a description will be made in connection with a different function. Referring to FIG. 17, moving path information generating apparatus 1700 includes walking information acquisition section 1701 and walking detection section 1702 in addition to the configuration of moving path information generating apparatus 10.

Walking information acquisition section 1701 is periodically activated and acquires walking information. Specifically, the walking information refers to data acquired by a sensor that detects movement of a person such as a vibration sensor, an acceleration sensor, or the like.

Walking detection section 1702 analyzes the walking information acquired by walking information acquisition section 1701 and detects whether walking is being performed. For example, the walking information may be analyzed by acquiring acceleration data in a direction vertical to the ground and observing periodicity thereof. The presence or absence of periodicity may be detected, for example, by determining whether an interval of a peak value of acceleration data is almost equal or by performing a frequency transform such as the Fourier transform on acceleration data and determining whether it is a frequency that a power spectrum protrudes and increases. When walking is detected using periodicity, walking detection section 1702 commands azimuth information acquisition section 11 to perform azimuth information acquisition.

Azimuth information acquisition section 11 receives the azimuth information acquisition command from walking detection section 1702 and performs azimuth information acquisition. The azimuth information acquisition is the same as in Embodiment 1. Accordingly, position information acquisition or path estimation can be suppressed at times other than walking, and thus the operation time of the terminal can increase.

### Embodiment 5

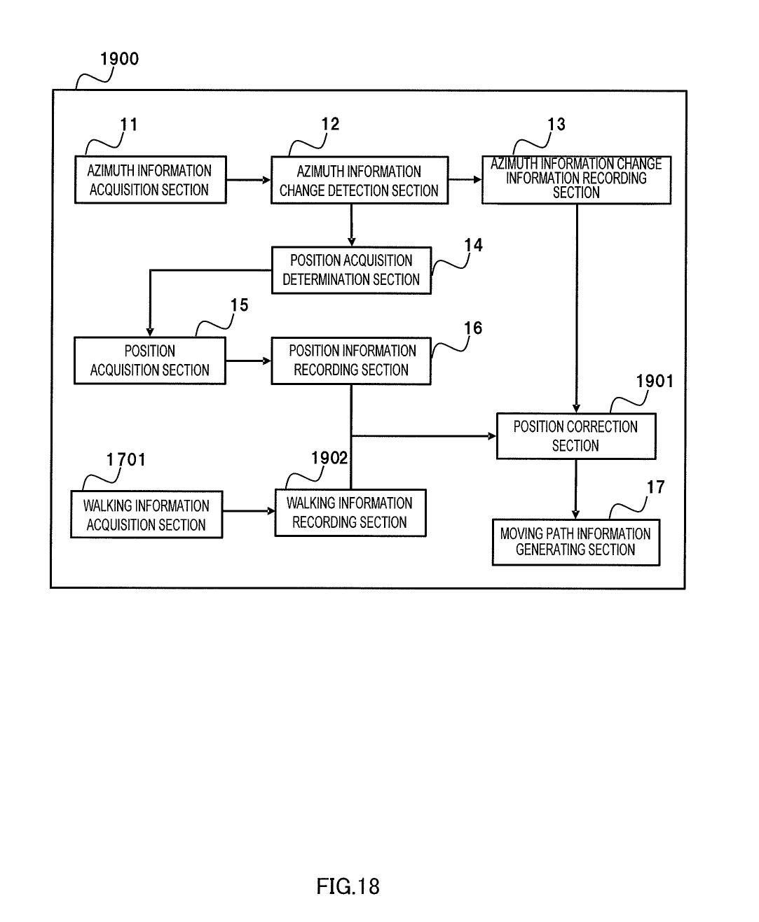

FIG. 18 is a configuration diagram of moving path information generating apparatus 1900 according to Embodiment 5 of the present invention. The configuration of Embodiment 5 is a configuration in which a function of performing position correction and a function of acquiring walking information as information necessary for position correction are added to the configuration of Embodiment 1. The position correction is performed as pre-processing of moving path information generation. The same parts as in the configurations of Embodiments 1 and 4 are assigned the same reference numerals, and a description will be made in connection with a different function.

Referring to FIG. 18, moving path information generating apparatus 1900 includes walking information acquisition section 1701, walking information recording section 1902, and position correction section 1901 in addition to the configuration of moving path information generating apparatus 10. Walking information acquisition section 1701 is basically the same as in Embodiment 4, and the acquired walking information is stored in walking information recording section 1902 as a pair of time and sensor data.

Position correction section 1901 determines whether position correction is to be performed based on the position information recorded in position information recording section 16 and azimuth information change information recorded in azimuth information change information recording section 13 and performs position correction using the walking information acquired by walking information acquisition section 1701.

Azimuth information change detection section 12 issues an azimuth information change ID on the detected azimuth information change. In the case of notifying the azimuth information change, azimuth information change detection section 12 adds the issued azimuth information change ID to information at the time of notice in Embodiment 1 and notifies position acquisition determination section 14 and azimuth information change information recording section 13 of the azimuth information change ID.

In the case of commanding position acquisition section 15 to perform position acquisition, position acquisition determination section 14 transfers the azimuth information change ID, and in the case of recording the position information, position information recording section 16 records the azimuth information change ID together with the acquired position information.

Similarly, azimuth information change information recording section 13 also records the azimuth information change ID together with the azimuth information change information received from azimuth information change detection section 12.

Next, a description will be made in connection with a position correction process of moving path information generating apparatus 1900. The position correction process is performed to obtain the original position that has been desired to acquire, that is, the position at a time when the azimuth information change has occurred in the case in which an azimuth information change time has been different from a position acquisition time.

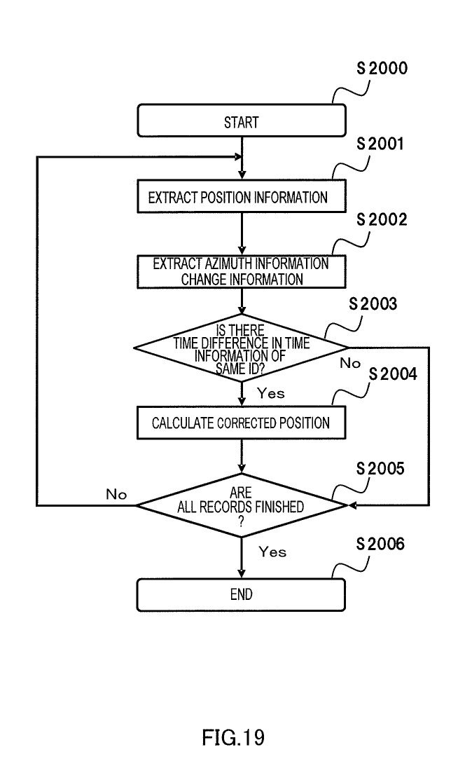

FIG. 19 is a flowchart of the position correction process of moving path information generating apparatus 1900. First, when the process starts (S2000), position correction section 1901 acquires the position information from position information recording section 16 (S2001).

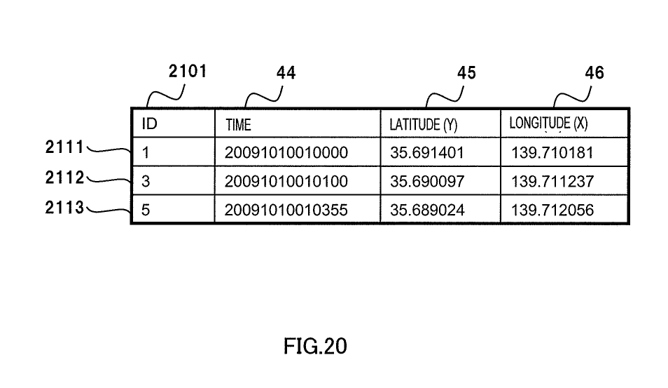

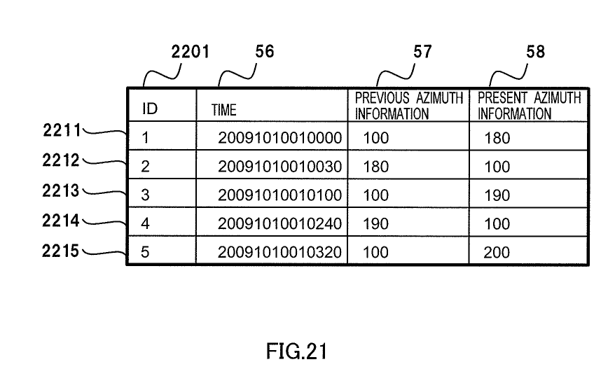

FIG. 20 shows a specific example of the position information. The position information is one in which azimuth information change ID 2101 is added to the position information of FIG. 5. FIG. 21 shows a specific example of the azimuth information change information. The azimuth information change information is one in which azimuth information change ID 2201 is added to the azimuth information change information of FIG. 6.

A record is acquired from corresponding azimuth information change information using azimuth information change ID 2101 of the position information as a key (S2002).

For example, when an azimuth information change ID (=1) of first record 2111 of the position information is used as a key, a record of 2211 can be acquired from the azimuth information change information. A time of the position information is compared with a time of the azimuth information change information. When there has been a time difference, it is determined that the position could not be acquired directly after the azimuth information change (S2003), and correction of the position is performed (S2004). For example, when the azimuth information change ID is 5, a time of position information 2113 is 20091010010355, and a time of position information 2215 is 20091010010320, so that there is a time difference of 35 seconds.

As a case in which it is difficult to acquire the position, for example, there is a case in which signals from GPS satellites cannot be received or a case in which a reception environment is bad and so a degree of accuracy of the calculated position is low. In this case, after waiting is performed until a reception environment gets better, position acquisition may be performed again.

Next, a method of calculating the corrected position (S2004) will be described. First, walking information between times of azimuth information change information and position information which have the same azimuth information change ID is acquired from walking information recording section 1701, and a walking speed is obtained based on the walking information. For example, when the walking information is acceleration data, a power spectrum is obtained by a frequency transform such as the Fourier transform, and a frequency at which the power spectrum becomes maximum may be regarded as a walking frequency. This is based on a characteristic that a change in acceleration acquired by walking is higher in periodicity than a change in acceleration acquired by other operations. If it is assumed that the length of stride has been registered in advance, the walking speed can be obtained by multiplying the length of stride by the walking frequency.

When the walking speed is multiplied by the time difference obtained in step S2003, the distance moved until the position acquisition is actually performed after there has been the azimuth information change is obtained. In the example in which the azimuth information change ID is 5, since the latitude of the corresponding record 2113 of the position information is 35.689024 and the longitude is 139.712056, the position that has advanced by the distance obtained by the walking speed is multiplied by the time difference (35 seconds) in a reverse direction, that is, a direction of 20° of the present azimuth information (=200) of the corresponding record 2215 of the azimuth information change information is the corrected position.

In step S2005, steps S2001 to S2004 are repetitively performed until all position information records are processed. When all position information records are processed, the position correction process is completed (S2006). The position correction may be performed only when a difference between the time of the position information and the time of the azimuth information change information is equal to or more than a predetermined value. As described above, moving path information generating apparatus 1900 according to the present embodiment can increase the degree of accuracy of path estimation by calculating a desired position through position correction even when timing for acquiring the position necessary for generating the moving path information is mismatched.

### Embodiment 6

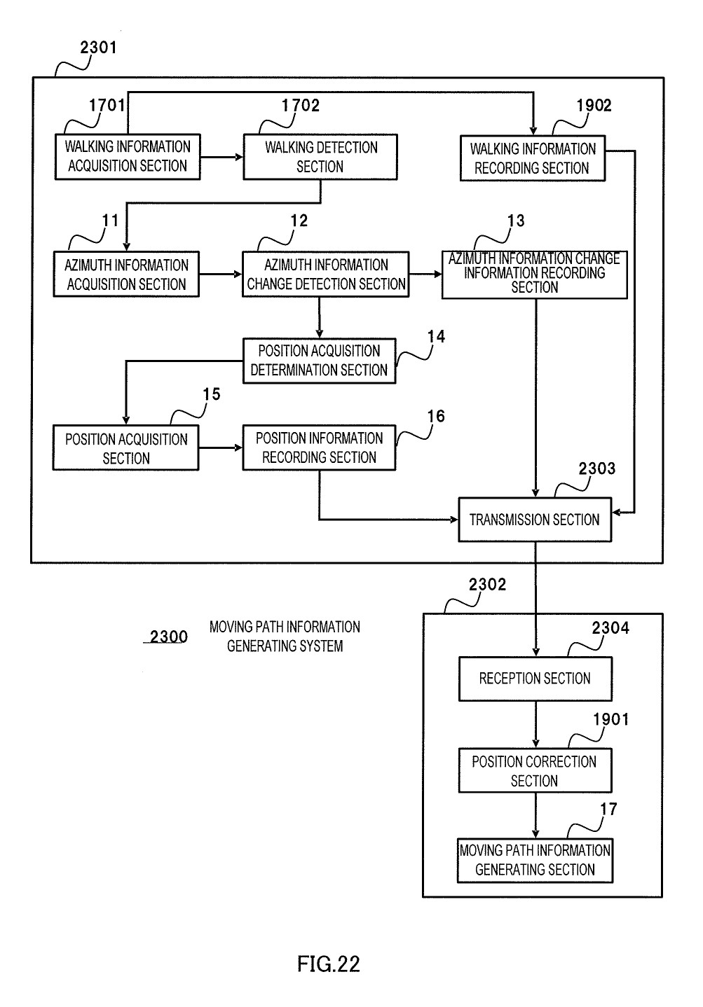

FIG. 22 is a configuration view of moving path information generating system 2300 of Embodiment 6 of the present invention. In FIG. 22, the same components as in FIGS. 2 and 17 are assigned the same reference numerals. Moving path information generating system 2300 of Embodiment 6 of the present invention includes position acquisition control terminal 2301 and moving path information generating apparatus 2302.

Position acquisition control terminal 2301 of the present embodiment is different from path acquisition control terminal 1501 in that walking information acquisition section 1701 and walking detection section 1702 for performing activation control of azimuth information acquisition are disposed, and walking information recording section 1902 for performing a position correction process in moving path information generating apparatus 2302 and transmission section 2302 for transmitting walking information to moving path information generating apparatus 2302 are disposed.

Moving path information generating apparatus 2302 is different from moving path information generating apparatus 1502 in that position correction section 1901 for performing position correction is disposed, and receiving section 2304 receives the walking information in addition to the position information and the azimuth information change information.

As described above, moving path information generating system 2300 according to the present embodiment can increase the operation time of the terminal by performing an operation only at the time of walking and increase the degree of accuracy of path estimation by calculating a desired position through position correction even when timing for acquiring the position necessary for generating the moving path information is mismatched.

The disclosure of Japanese Patent Application No. 2009-297401, filed on Dec. 28, 2009, including the specification, drawings and abstract, is incorporated herein by reference in its entirety.

### INDUSTRIAL APPLICABILITY

The present invention is suitable for use in healthy management, a logger, a traffic survey, or the like.

### REFERENCE SIGNS LIST

10: Moving path information generating apparatus
11: Azimuth information acquisition section
12: Azimuth information change detection section
13: Azimuth information change information recording section
14: Position acquisition determination section
15: Position acquisition section
16: Position information recording section
17: Moving path information generating section
1500: Moving path information generating system
1501: Position acquisition control terminal
1502: Moving path information generating apparatus
1503: Transmission section
1504: Reception section

1. A moving path information generating apparatus, comprising:
an azimuth information acquisition section that acquires azimuth information by an azimuth information sensor;
an azimuth information change detection section that detects a change in the azimuth information acquired by the azimuth information acquisition section;
an azimuth information change information recording section that records azimuth information change information including the azimuth information acquired by the azimuth information acquisition section when the azimuth information change detection section has detected the azimuth information change;
a position acquisition determination section that commands position acquisition when the azimuth information change detection section detects the azimuth information change and position acquisition has not been commanded at the time of a previous azimuth information change;
a position acquisition section that receives a position acquisition command from the position acquisition determination section and performs position acquisition;
a position information recording section that records position information including a position acquired by the position acquisition section; and
a moving path information generating section that calculates a position that has not been acquired by the position acquisition section at the time of azimuth information change using the azimuth information change information and the position information, and generates moving path information.

2. The moving path information generating apparatus according to claim 1, wherein the moving path information generating section calculates the position that has not been acquired by the position acquisition section at the time of the azimuth information change using a position in which there has been an azimuth information change directly before the position that has not been acquired and a position in which there has been an azimuth information change directly after the position that has not been acquired among the azimuth information change information and the position information.

3. The moving path information generating apparatus according to claim 1, wherein the position acquisition determination section has a position acquisition flag representing whether position acquisition has been commanded when there has been a previous azimuth information change.

4. The moving path information generating apparatus according to claim 1, wherein the position acquisition determination section commands position acquisition at the time of a U turn even when position acquisition has been commanded when there has been a previous azimuth information change.

5. The moving path information generating apparatus according to claim 1, wherein the azimuth information acquisition section receives an azimuth information acquisition cycle information from the outside and acquires azimuth information with the period of the azimuth information acquisition cycle.

6. The moving path information generating apparatus according to claim 1, further comprising a switching section that stops azimuth information acquisition by the azimuth information acquisition section and switches to a mode in which the position acquisition section periodically performs position acquisition, at a recording frequency of position information recorded by the position information recording section.

7. A method of generating moving path information, comprising:
an azimuth information acquisition step of acquiring an azimuth;
an azimuth information change detection step of detecting a change in the azimuth information acquired in the azimuth information acquisition step;
an azimuth information change information recording step of recording azimuth information change information including the azimuth information acquired in the azimuth information acquisition section when the azimuth information change is detected in the azimuth information change detection step;
a position acquisition determination step of commanding position acquisition when the azimuth information change has been detected in the azimuth information change detection step and position acquisition has not been commanded at the time of a previous azimuth information change;
a position acquisition step of receiving position acquisition when a position acquisition command is output in the position acquisition determination step;
a position information recording step of recording position information including a position acquired in the position acquisition step; and
a moving path information generation step of calculating a position that has not been acquired in the position acquisition step at the time of azimuth information change using the azimuth information change information and the position information, and generating moving path information.

8. A moving path information generating system, comprising a position acquisition control terminal and a moving path information generating apparatus, wherein:
the position acquisition control terminal comprises:
an azimuth information acquisition section that acquires azimuth information;
an azimuth information change detection section that detects a change in the azimuth information acquired by the azimuth information acquisition section;
an azimuth information change information recording section that records azimuth information change information from the azimuth information change detection section when the azimuth information change detection section has detected the azimuth information change,
a position acquisition determination section that commands position acquisition when the azimuth information change detection section detects the azimuth information change and position acquisition has not been commanded at the time of a previous azimuth information change,
a position acquisition section that receives a position acquisition command from the position acquisition determination section and performs position acquisition,
a position information recording section that records position information including a position acquired by the position acquisition section, and
a transmission section that transmits the azimuth information change information and the position information, and
the moving path information generating apparatus comprises:
a reception section that receives the azimuth information change information and the position information; and
a moving path information generating section that calculates a position that has not been acquired at the time of azimuth information change using the azimuth information change information and the position information and generates moving path information.

9. A position acquisition control terminal, comprising:
an azimuth information acquisition section that acquires azimuth information;
an azimuth information change detection section that detects a change in the azimuth information acquired by the azimuth information acquisition section;
an azimuth information change information recording section that records azimuth information change information from the azimuth information change detection section when the azimuth information change detection section has detected the azimuth information change;
a position acquisition determination section that commands position acquisition when the azimuth information change detection section detects the azimuth information change and position acquisition has not been commanded at the time of a previous azimuth information change;
a position acquisition section that receives a position acquisition command from the position acquisition determination section and performs position acquisition;
a position information recording section that records position information including a position acquired by the position acquisition section; and
a transmission section that transmits the azimuth information change information and the position information.

10. A moving path information generating apparatus, comprising:
a reception section that receives the azimuth information change information and the position information from the position acquisition control terminal according to claim 9; and
a moving path information generating section that calculates a position that has not been acquired at the time of azimuth information change using the azimuth information change information and the position information and generates moving path information.

11. The moving path information generating apparatus according to claim 1, further comprising:
a walking information acquisition section that acquires movement information of a person necessary for determining whether the person is walking; and
a walking detection section that determines a walking state based on the walking information and commands azimuth information acquisition when walking is being performed, wherein the azimuth information acquisition section performs azimuth information acquisition in response to an azimuth information acquisition command received from the walking detection section.

12. The moving path information generating apparatus according to claim 1, further comprising:
a walking information acquisition section that acquires movement information of a person necessary for determining whether the person is walking;
a walking information recording section that records the walking information; and
a position correction section that performs position correction using the walking information when a difference between an azimuth information change time of the azimuth information change information and a position acquisition time of the position information is equal to or more than a predetermined value.

13. The moving path information generating system according to claim 8, wherein:
the position acquisition control terminal comprises:
a walking information acquisition section that acquires movement information of a person necessary for determining whether the person is walking; and
a walking detection section that determines a walking state based on the walking information and commands azimuth information acquisition when walking is being performed, and a walking information recording section that records the walking information;
the transmission section of the position acquisition control terminal transmits the walking information in addition to the position information and the azimuth information change information;
the reception section of the moving path information generating apparatus receives the walking information in addition to the position information and the azimuth information change information; and
the moving path information generating apparatus further comprises a position correction section that performs position correction using the walking information when a difference between an azimuth information change time of the azimuth information change information and a position acquisition time of the position information is equal to or more than a predetermined value.
